(19) United States
(12) Patent Application Publication
(10) Pub. No.: US 2006/0278160 A1
(43) Pub. Date: Dec. 14, 2006

(54) PHOTORESIST COATING METHOD AND APPARATUS FOR PERFORMING SAME

(75) Inventors: Yu-Huang Su, Tao Yuan Shien (TW); Shih-Jen Chen, Tao Yuan Shien (TW); Chen-Nan Chou, Tao Yuan Shien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: QUANTA DISPLAY INC., Tao Yuan Shien (TW)

(21) Appl. No.: 11/382,339

(22) Filed: May 9, 2006

(30) Foreign Application Priority Data
Jun. 14, 2005 (TW) 94119623

(51) Int. Cl. B05B 15/02; B05C 5/00

(52) U.S. Cl. 118/302; 118/305

(57) ABSTRACT

A photoresist coating apparatus comprises a photoresist coating device, a cleaning device and a stage. A substrate is placed on the stage. In a photoresist coating process, the cleaning device removes particles on the substrate first. The photoresist coating device then sprays a photoresist material uniformly on a surface of the substrate.

### BACKGROUND

The invention relates to a photoresist coating apparatus, and more particularly to a photoresist coating apparatus reducing particles deposited therein.

FIG. 1a shows a conventional photoresist coating apparatus utilized in large-sized liquid crystal panel coating process, wherein a photoresist coating device 10 moves slowly in a first direction x to uniformly coat a photoresist material 2 on a surface of a substrate 1. With reference to FIG. 1b, the photoresist coating device 10 comprises a nozzle 11. A slot 12 is formed in the center of the nozzle 11, and the photoresist material 2 is sprayed from the slot 12. The photoresist coating apparatus as shown in FIGS. 1a and 1b is provided by TOKYO OHKA KOGYO Co. (TOK).

However, in a photoresist coating process, particles produced by the apparatus, or carried by the substrate or by a transporting device are deposited in the photoresist coating apparatus over time, which will pollute the substrate, and decrease reliability of final products.

### SUMMARY

In one embodiment, a photoresist coating apparatus of the invention comprises a photoresist coating device, a cleaning device and a stage. A substrate is placed on the stage. In a photoresist coating process, the cleaning device removes particles on the substrate first. The photoresist coating device then sprays a photoresist material uniformly on a surface of the substrate.

The apparatus of the invention cleans the substrate before coating photoresist thereon. The number of particles on the surface of the substrate is thus reduced and the reliability of the final product is improved. The apparatus of the invention can additionally cleans the stage, and the number of particles in the photoresist coating apparatus is decreased and controlled.

### BRIEF DESCRIPTION OF THE DRAWINGS

The invention will be more fully understood from the following detailed description and the accompanying drawings, given by the way of illustration only and thus not intended to limit the disclosure.

FIG. 1a shows a conventional photoresist coating apparatus;

FIG. 1b shows a detailed structure of the conventional photoresist coating apparatus;

FIG. 2 shows a photoresist coating apparatus of the invention;

FIG. 3a is a cross-sectional view of a cleaning device along direction A-A of FIG. 2;

FIG. 3b is an upward view of the cleaning device;

FIG. 3c shows the cleaning device cleaning a substrate;

FIG. 3d shows a modified embodiment of the invention;

FIG. 3e shows the cleaning device of FIG. 3d cleaning a substrate;

FIGS. 4a-4d show the operation of the photoresist coating apparatus of the invention.

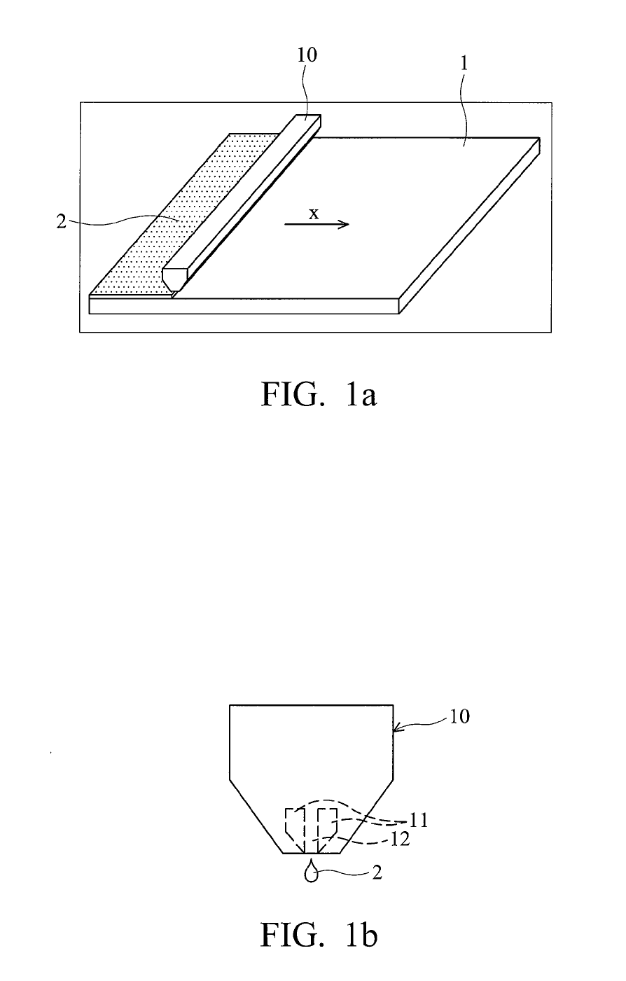

### DETAILED DESCRIPTION

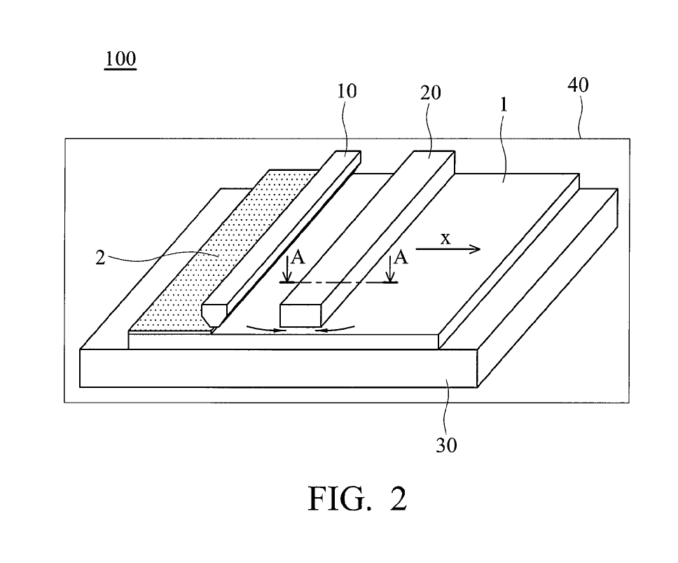

FIG. 2 shows a photoresist coating apparatus 100 of the invention, which comprises a photoresist coating device 10, a cleaning device 20, a stage 30 and a process chamber 40. The photoresist coating device 10, the cleaning device 20 and the stage 30 are disposed in the process chamber 40. A substrate 1 is disposed on the stage 30. During a photoresist coating process, the cleaning device 20 first removes particles on the substrate 1. The photoresist coating device 10 then coats a photoresist material 2 on a surface of the substrate 1 by spraying.

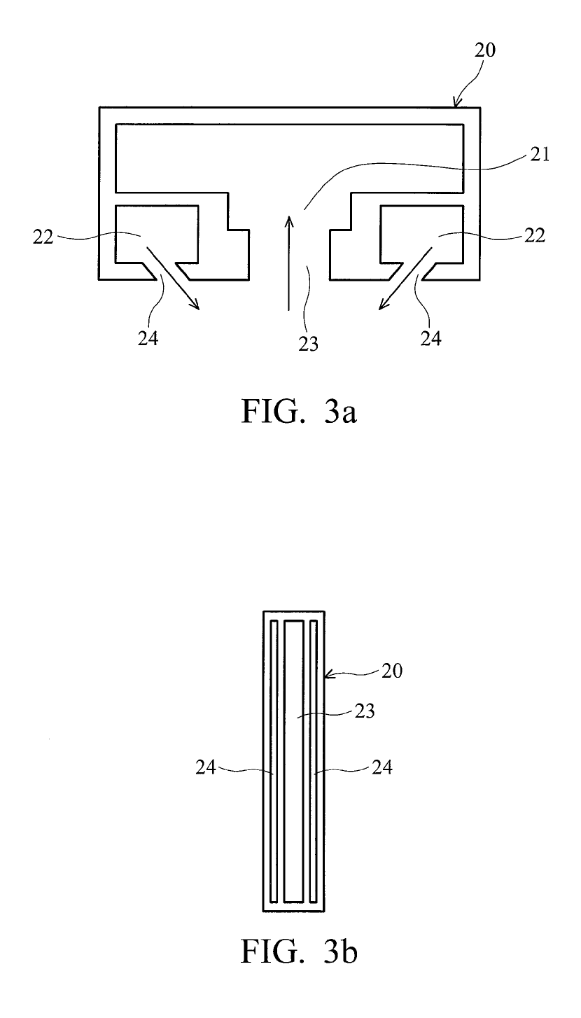

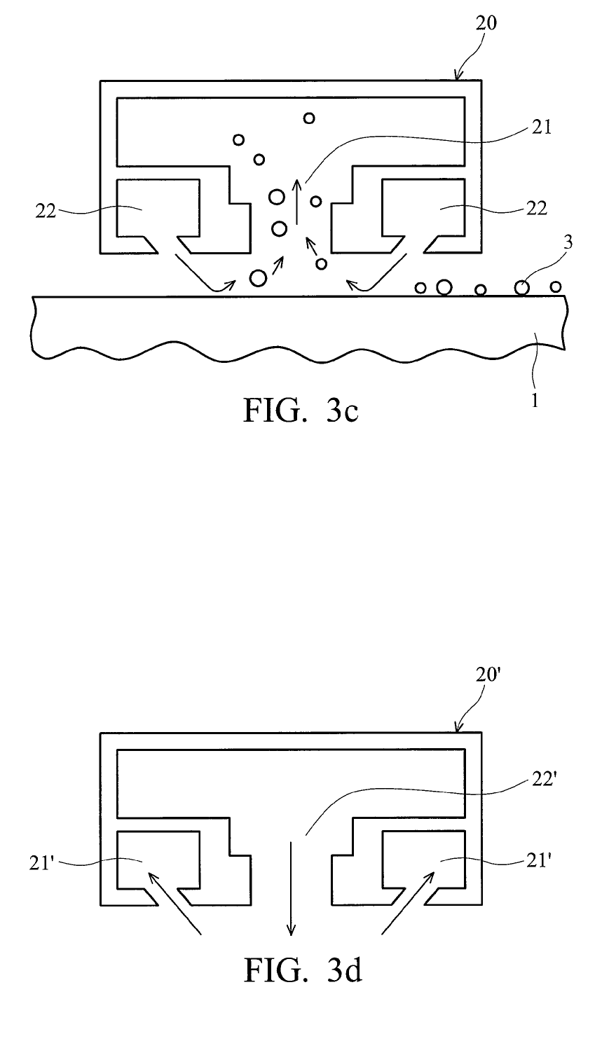

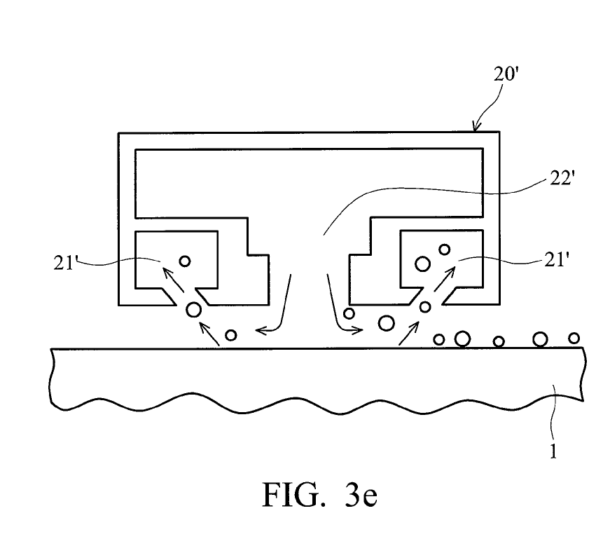

FIG. 3a is a cross-sectional view of the cleaning device 20 along direction A-A of FIG. 2. The cleaning device 20 comprises an inhaling unit (inhaling chamber) 21 and two blowing units (blowing chambers) 22. The inhaling unit 21 is disposed between the blowing units 22. The inhaling unit 21 comprises an outlet 23. Each blowing unit 22 comprises an inlet 24. FIG. 3b is an upward view of the cleaning device 20. As shown in FIG. 3b, the outlet 23 and inlets 24 are slots with widths about 1 to 2 mm. With reference to FIG. 3c, the blowing units 22 are connected to a blowing pipe (not shown). During cleaning, the blowing units 22 blow air toward the substrate 1 to remove particles 3 from the surface of the substrate 1. Meanwhile, the inhaling unit 21 removes the particles 3 therethrough by vacuum suction. The inhaling unit 21 is connected to a vacuum pipe (not shown). The particles 3 inhaled into inhaling unit 21 are moved out of the photoresist coating apparatus 100 through the vacuum pipe. A blowing pressure of the blowing units 22 is about 12 to 14 kPa. An inhaling pressure of the inhaling unit 21 is about −12 to −14 kPa. The inhaling pressure of the inhaling unit 21 is preferably stronger than the blowing pressure of the blowing units 22.

FIG. 3d shows a modified example of a cleaning device 20′, wherein a blowing unit 22′ is disposed between two inhaling units 21′. With reference to FIG. 3e, the blowing unit 22′ is connected to a blowing pipe (not shown). During a cleaning procedure, the blowing unit 22′ blows air toward the substrate 1 to detach particles 3 from the surface of the substrate 1. Meanwhile, the inhaling units 21′ remove the particles 3 therethrough by vacuum suction. The inhaling units 21′ are connected to a vacuum pipe (not shown). The particles 3 inhaled into inhaling units 21′ are moved out of the photoresist coating apparatus 100 through the vacuum pipe.

In the embodiments mentioned above, the inhaling unit and the blowing unit are chamber structures, and the inlet and the outlet are slots. However, the invention is not limited to this. For example, the inhaling unit and the blowing unit can be a pipe structure, and the inlet and the outlet can be through holes, or, the blowing unit can be eliminated, and the particles can be removed by the inhaling unit only.

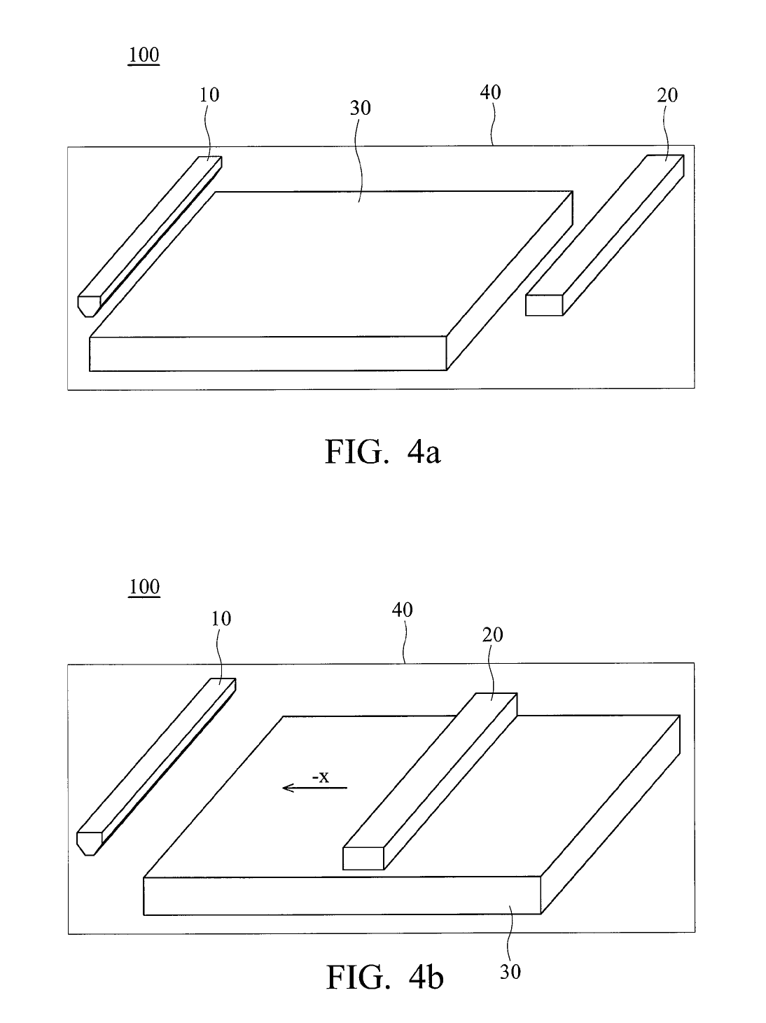

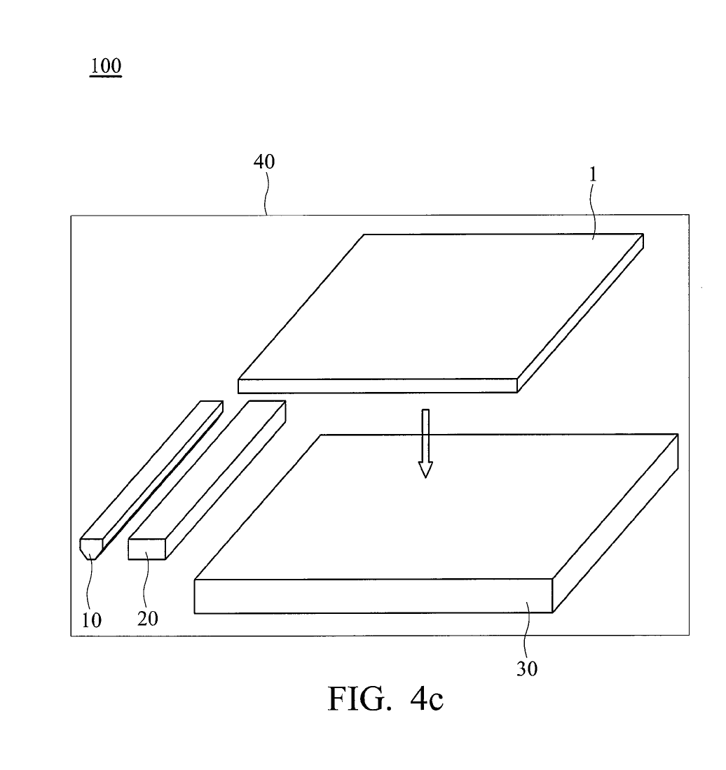

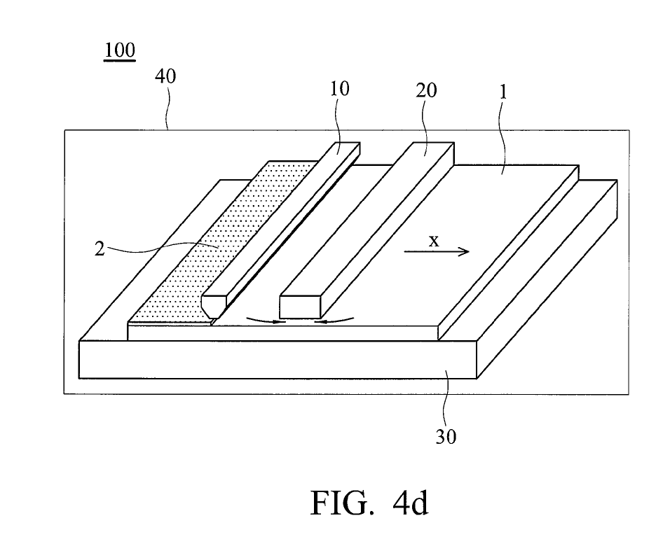

The operation of the photoresist coating apparatus 100 is disclosed in the following description. With reference to FIG. 4a, initially, in the process chamber 40, the photoresist coating device 10 is in a first position and the cleaning device 20 is in a second position. Next, as shown in FIG. 4b, the cleaning device 20 moves from the second position to the first position in a second direction −x, and removes particles from the stage 30 in a scanning manner. With reference to FIG. 4c, after the cleaning device 20 cleans the stage 30 and stays in the first position, the substrate 1 is transported to the stage 30 by a transporting device (not shown). Then, as shown in FIG. 4d, the photoresist coating device 10 and the cleaning device 20 move from the first position to the second position in the first direction x simultaneously. In this step, the cleaning device 20 moves before the photoresist coating device 10. The cleaning device 20 first removes particles from the substrate 1. The photoresist coating device 10 then coats the photoresist material 2 on the substrate 1 by spraying. After coating the photoresist material 2, the substrate 1 is removed, the cleaning device 20 stays in the second position, and the photoresist coating device 10 moves from the second position to the first position in the second direction −x (as shown in FIG. 4a).

The apparatus of the invention cleans the substrate prior to a photoresist coating procedure. The number of particles on the surface of the substrate is thus reduced and the reliability of the final product is improved. The apparatus of the invention additionally cleans the stage, and the number of particles in the photoresist coating apparatus is decreased and controlled.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A photoresist coating apparatus for coating a photoresist material on a substrate, comprising:
a stage for supporting the substrate;
a cleaning device movable above the stage and for removing a plurality of particles by vacuum suction; and
a photoresist coating device for coating the photoresist material on the substrate.

2. The photoresist coating apparatus as claimed in claim 1, wherein the cleaning device removes the particles from the substrate in a scanning manner.

3. The photoresist coating apparatus as claimed in claim 1, wherein the photoresist coating device coats the photoresist material by spraying.

4. The photoresist coating apparatus as claimed in claim 1, wherein the cleaning device comprises a blowing unit and an inhaling unit, the blowing unit blows air toward the substrate for detaching the particles thereon, and the inhaling unit removes the particles by vacuum suction.

5. The photoresist coating apparatus as claimed in claim 4, wherein the blowing unit comprises an inlet which is a slot.

6. The photoresist coating apparatus as claimed in claim 5, wherein a width of the inlet is about 1-2 mm.

7. The photoresist coating apparatus as claimed in claim 4, wherein the inhaling unit comprises an outlet which is a slot.

8. The photoresist coating apparatus as claimed in claim 7, wherein a width of the outlet is about 1 to 2 mm.

9. The photoresist coating apparatus as claimed in claim 4, wherein a blowing pressure of the blowing unit is about 12 to 14 kPa.

10. The photoresist coating apparatus as claimed in claim 4, wherein an inhaling pressure of the inhaling unit is about −12 to −14 kPa.

11. The photoresist coating apparatus as claimed in claim 1, wherein the cleaning device comprises two blowing units and an inhaling unit, the inhaling unit is disposed between the blowing units, the blowing units blow air toward the substrate for removing the particles thereon, and the inhaling unit removes the particles by vacuum suction.

12. The photoresist coating apparatus as claimed in claim 1, wherein the cleaning device comprises a blowing unit and two inhaling units, the blowing unit is disposed between the inhaling units, the blowing unit blows air toward the substrate for removing the particles thereon, and the inhaling units remove the particles by vacuum suction.

13. The photoresist coating apparatus as claimed in claim 1, further comprising a process chamber, wherein the platform, the cleaning device and the photoresist coating device are disposed therein.

14. A photoresist coating method, comprising:
(a) providing the photoresist coating apparatus as claimed in claim 1;
(b) disposing the substrate on the stage;
(c) moving the cleaning device and the photoresist coating device from a first position to a second position in a first direction simultaneously, wherein the cleaning device moves in front of the photoresist coating device, the cleaning device removes the particles from the substrate previously, and then the photoresist coating device coats the photoresist material on substrate.

15. The photoresist coating method as claimed in claim 14, further comprising:
(d) removing particles from the stage by the cleaning device before disposing the substrate on the stage.

16. The photoresist coating method as claimed in claim 15, wherein in the step (d), the cleaning device is moved from the second position to the first position in a second direction, and removes particles from the stage.

17. The photoresist coating method as claimed in claim 14, further comprising:
(e) moving the photoresist coating device from the second position to the first position in a second direction away from the cleaning device.
